(19) United States
(12) Patent Application Publication
(10) Pub. No.: US 2017/0358045 A1
(43) Pub. Date: Dec. 14, 2017

(54) DATA ANALYSIS SYSTEM, DATA ANALYSIS METHOD, AND DATA ANALYSIS PROGRAM

(71) Applicant: FRONTEO, Inc., Minato-ku, Tokyo (JP)

(72) Inventors: Hideki TAKEDA, Tokyo (JP); Kazumi HASUKO, Tokyo (JP)

(21) Appl. No.: 15/548,887

(22) PCT Filed: Feb. 6, 2015
(86) PCT No.: PCT/JP2015/053430

§ 371 Date: Aug. 4, 2017

(51) Int. Cl. G06Q 50/18; G06F 17/30; G06N 99/00

(52) U.S. Cl. CPC G06Q 50/184; G06N 99/005; G06F 17/30011

(57) ABSTRACT

Regarding a data analysis system, a data acquisition unit acquires, as a training data set, a data set including a plurality of combinations of training data and classification information for classifying the training data. A relation evaluation unit that evaluates a relation between a data element included in the training data and the classification information. A partial data generation unit that divides each of a plurality of pieces of unknown data, which are analysis targets, into partial unknown data which constitute part of each pieces of the unknown data. A data evaluation unit that evaluates each piece of the partial unknown data on the basis of evaluation results by the relation evaluation unit.

### TECHNICAL FIELD

The present invention relates to a data analysis system, data analysis method, and data analysis program and, for example, the invention relates to a data analysis system, data analysis method, and data analysis program that can be used for patent document searches.

### BACKGROUND ART

In recent years, intellectual property rights such as patent rights have been growing increasingly important. So, there have been proposed techniques for, for example, analyzing keywords which appear in patent publications or the like and evaluating values of intellectual properties of the relevant patent publications or the like (for example, see PTL 1).

### CITATION LIST

### Patent Literature

PTL 1: Japanese Patent Application Laid-Open (Kokai) Publication No. 2010-009493

### SUMMARY OF THE INVENTION

### Problems to be Solved by the Invention

Generally, the value of an intellectual property varies depending on who owns that intellectual property, and it is a difficult issue to evaluate a versatile value. For example, intellectual properties related to a certain business are important for a person who runs that business, while intellectual properties which are not related to that business may be devaluated.

For a person who intends to run a certain business, whether a patent right in a technique related to that business can be obtained or not, or whether others' patent rights related to that business can be nullified or avoided is important. Therefore, it is believed that the person who intends to run a certain business wants to realize acceleration of patent searches, such as invalid material searches and prior art searches of patent documents, and reduction of burdens rather than to know absolute value evaluation of techniques related to that business.

The inventors of the present application have come to realize the usability of a technique that supports finding of data related to documents in which specified events, ideas, and so on are described, from among a large amount of unknown data by means of, for example, the above-mentioned patent searches.

The present invention was devised in light of the above-described circumstances and it is an object of the invention to provide a technique that supports finding of data related to data in which specified ideas, events, and so on are described, from among a large amount of unknown data.

### Means to Solve the Problems

In order to solve the above-described problems, a data analysis system according to an aspect of the present invention includes: a data acquisition unit that acquires, as a training data set, a data set including a plurality of combinations of training data and classification information for classifying the training data; a relation evaluation unit that evaluates a relation between a data element included in the training data and the classification information; a partial data generation unit that divides each of a plurality of pieces of unknown data, which are analysis targets, into partial unknown data which constitute part of each pieces of the unknown data; and a data evaluation unit that evaluates each piece of the partial unknown data on the basis of evaluation results by the relation evaluation unit.

The data evaluation unit may evaluate each piece of the partial unknown data by calculating a score indicative of strength of a relation between the partial unknown data and the classification information.

The data analysis system may further include an evaluation integration unit that generates an integrated index which integrates evaluation results by the data evaluation unit.

The data evaluation unit may calculate a score indicative of strength of a relation between the partial unknown data and the classification information so that when a relation between a data element included in the partial unknown data and the classification information is strong, a value of the score will become larger than a case where the relation is weak; and the evaluation integration unit may generate an integrated score as the integrated index by summing a specified number of the score, which is calculated by the data evaluation unit, in descending order.

The unknown data may be document data created according to a specified format including a plurality of items and the partial data generation unit may generate the partial unknown data by dividing the unknown data on the basis of the items as units.

Another aspect of the present invention is a data analysis method. This method includes the following steps executed by a processor: a data acquisition step of acquiring, as a training data set, a data set including a plurality of combinations of training data and classification information for classifying the training data; a relation evaluation step of evaluating a relation between a data element included in the training data and the classification information; a partial data generation step of dividing each of a plurality of pieces of unknown data, which are analysis targets, into partial unknown data which constitute part of each pieces of the unknown data; and a data evaluation step of evaluating each piece of the partial unknown data on the basis of evaluation results by the relation evaluation unit.

### Advantageous Effects of the Invention

The data analysis system, data analysis method, and data analysis program according to the present invention can provide a technique that supports finding of data related to data in which, for example, specific ideas and events are described from a large amount of unknown data.

### BRIEF DESCRIPTION OF DRAWINGS

FIG. 1 is a diagram schematically illustrating a functional configuration of a data analysis system according to an embodiment of the present invention;

FIG. 2 is a diagram schematically illustrating an example of a format of unknown data;

FIG. 3 is a diagram schematically illustrating an internal configuration of an integrated evaluation according to the embodiment;

FIG. 4 is a graph showing evaluation results of performance of the data analysis system according to the embodiment;

FIG. 5 is a graph showing other evaluation results of performance of the data analysis system according to the embodiment;

FIG. 6 is a flowchart for explaining a flow of data analysis processing executed by the data analysis apparatus according to the embodiment; and

FIG. 7 is a flowchart for explaining a flow of integrated score generation processing executed by the evaluation integration unit according to the embodiment.

### DESCRIPTION OF EMBODIMENTS

The outlines of a data analysis system according to an embodiment will be described.

A data analysis system according to an embodiment can, for example, support implementation of patent invalidity searches and prior art searches before patent applications. When the data analysis system is applied to an invalidity search, texts included in claims and a description of an invalidation target patent, and patent documents and papers concerning which their weak relation to the invalidation target patent is recognized by a user in advance are set as training data. Specifically speaking, data which are set as the training data by the data analysis system according to the embodiment are data associated with classification information by the user in advance, to indicate that such data is data of the invalidation target patent or data with the weak relation to the invalidation target patent.

The data analysis system evaluates the relation between data elements included in the training data and the classification information and evaluates the possibility of falling under invalid materials from a large amount of search object data (for example, unknown data such as patent documents and papers) by using the results of the above-described evaluation. Incidentally, a “data element(s)” is a set of character strings which has a certain meaning in a certain language, that is, so-called a “keyword(s)” (for example, a morpheme(s)).

In the case of the invalidity search, parts of a document which is a search target (for example, some paragraphs and/or some drawings) may often become the grounds for invalidity rather than a case where the entire document may become the grounds for invalidity. Similarly, in the case of the prior art search, parts of a document which is a search target (for example, some paragraphs and/or some drawings) may often fall under the prior art rather than a case were the entire document may fall under the prior art. Therefore, the data analysis system according to the embodiment divides the search target document into a plurality of pieces of partial unknown data and evaluates the possibility that each piece of the partial unknown data may fall under the invalid material or the prior art. Furthermore, the data analysis system integrates the score calculated for each piece of the partial unknown data on a document basis and evaluates the usability of the entire document as the invalid material or the prior art document.

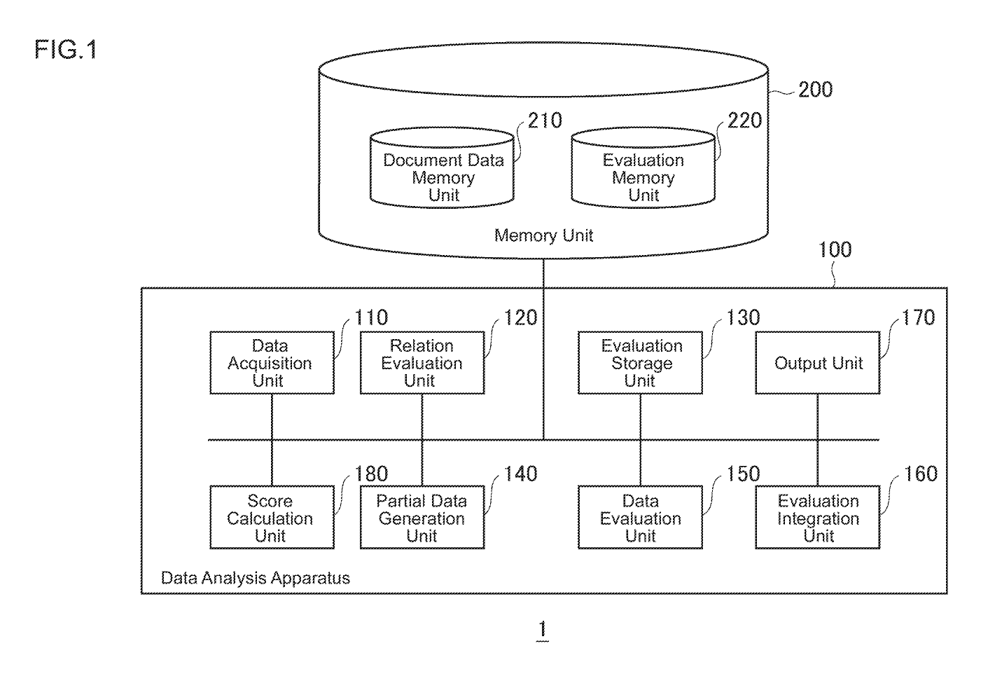

FIG. 1 is a diagram schematically illustrating a functional configuration of a data analysis system 1 according to an embodiment. The data analysis system 1 according to the embodiment includes a data analysis apparatus 100 and a memory unit 200.

FIG. 1 illustrates the functional configuration of the data analysis system 1 according to the embodiment to implement data analysis and other configurations are omitted. Referring to FIG. 1, the respective elements described as functional blocks for executing various processing can be configured by a CPU (Central Processing Unit), a main memory, and other LSI (Large Scale Integration) circuits in terms of hardware. Furthermore, the respective elements are implemented by, for example, a program loaded to the main memory in terms of software. Incidentally, this program may be stored in a computer-readable storage medium and may be downloaded from a network via a communication line. Therefore, those skilled in the art understand that these functional blocks can be implemented in various forms such as only hardware, only software, or a combination of hardware and software without limitation to any one of them.

When each functional unit of the data analysis system 1 illustrated in FIG. 1 is implemented by software, the data analysis apparatus 100 is implemented by executing orders of a program which is software for implementing each function. A “non-transitory tangible medium such as a tape, disk, card, semiconductor memory, or programmable logical circuit can be used as a storage medium for storing this program. Furthermore, the above-described program may be supplied to the above-described computer via an arbitrary transmission medium (such as a communication network or a broadcast wave) capable of transmitting the program. The present invention can be also implemented in a form of a data signal which is embodied by electronic transmission of the above-described program and is embedded in a carrier wave.

The data analysis apparatus 100 according to the embodiment includes a data acquisition unit 110, a relation evaluation unit 120, an evaluation storage unit 130, a partial data generation unit 140, a data evaluation unit 150, an evaluation integration unit 160, an output unit 170, and a score calculation unit 180. Moreover, the memory unit 200 according to the embodiment includes a document data memory unit 210 and an evaluation memory unit 220. The data analysis apparatus 100 can be implemented by using, as examples without limitation, a mainframe, a server, a workstation, cloud computing, a PC, and so on.

According to an example of the data analysis system 1 illustrated in FIG. 1, the memory unit 200 is implemented as an external device independent of the data analysis apparatus 100. In this case, the data analysis apparatus 100 and the memory unit 200 do not necessarily have to be in contiguity with each other and they may be connected remotely, for example, via a network. Furthermore, although not shown in the drawing, the memory unit 200 may be mounted inside of the data analysis apparatus 100 as part of the data analysis apparatus 100.

Furthermore, each unit included in the data analysis apparatus 100 does not necessarily have to be included in a single device. The data analysis apparatus 100 may be implemented by using, for example, the cloud computing technique; and in this case, a plurality of computers may cooperate with each other to implement each function of the data analysis apparatus 100.

The document data memory unit 210 for the memory unit 200 stores training data and a plurality of pieces of unknown data. The training data is a pair (combination) of “data” and “classification information” (whether related or not). Specifically speaking, when the data analysis system 1 according to the embodiment is applied to the patent invalidity search, the “data” is statements of patent claims and text data in descriptions and the “classification information” is information indicating whether or not the data is related to the statements of claims and the text data in a description of a patent which the user wishes to invalidate. Furthermore, when the data analysis system 1 is applied to the prior art search before filing of the patent application, the “classification information” is information indicating whether or not the data is related to an invention which is the target of the prior art search.

The “unknown data” is data which is a search target for the data analysis system 1 according to the embodiment and to which the above-mentioned “classification information” is not assigned. In other words, it indicates data concerning which the data analysis system needs to estimate the “classification information” in the form of a “score.” Specifically speaking, when the data analysis system 1 according to the embodiment is applied to the patent invalidity search or the prior art search, patent documents (laid-open publications and patent publications) and technical papers are main unknown data. However, the data (the training data and the unknown data) are not limited to the patent documents or technical papers and may be arbitrary text data (data at least partially including texts such as e-mails, presentation materials, spreadsheet materials, meeting materials, contracts, organization charts, and business plans), voice data, image data, video data, and so on. Incidentally, when the data analysis system 1 uses the voice data as an analysis target, the “data elements” may be partial voice data which constitute at least part of the voice data; when the data analysis system 1 uses the image data as the analysis target, the “data elements” may be partial image data which constitute at least part of the image data; and when the data analysis system 1 uses the video data as the analysis target, the “data elements” may be partial video data (such as frame images) which constitute at least part of the video data.

The data acquisition unit 110 refers to the document data memory unit 210 and acquires a data set including a plurality of combinations of the training data and the classification information for classifying the training data as a training data set. The classification information is information indicating whether certain data included in the training data is data which is the purpose of the search (so-called “correct data”) or data with a low relation to the data which is the purpose of the search (so-called “incorrect data”). The training data are stored in the data acquisition unit 110 in advance by, for example, the user. Alternatively, the data acquisition unit 110 can acquire the training data from a storage device which is connected in a manner capable of communications. The classification information may be, by way of example and without limitation to, “1” assigned to the correct data and “−1” assigned to the incorrect data.

Incidentally, the data acquisition unit 110 may refer to the document data memory unit 210 and recognize a specified number of pieces of unknown data acquired from a plurality of pieces of unknown data, which are search targets, as the aforementioned incorrect data. In this case, when extracting the plurality of pieces of unknown data stored in the document data memory unit 210, the data acquisition unit 110 may perform sampling randomly and acquire the specified number of pieces of the unknown data. The data acquisition unit 110 may extract, for example, 10% documents randomly from the entire unknown data and this percentage can be freely set by the user.

The relation evaluation unit 120 evaluates the relation between data elements included in the training data and the classification information. More specifically, the relation evaluation unit 120 evaluates the data elements extracted from the training data acquired by the data acquisition unit 110 in accordance with specified standards. In other words, the relation evaluation unit 120 can learn patterns (widely including abstract concepts and meanings and without limitation to so-called “specified patterns” [for example, specified design patterns or regularity]) included in the training data by evaluating the degree of contribution to combinations included in the training data set, which has been acquired by the data acquisition unit 110, by the data elements constituting at least part of the training data. Incidentally, the “specified standards” will be explained later.

The evaluation storage unit 130 associates the evaluation results by the relation evaluation unit 120 with the data elements regarding which the relation is evaluated, and stores the evaluation results in the memory unit. The unknown data are analyzed on the basis of the data elements and their evaluation results which are stored in the evaluation memory unit 220.

The partial data generation unit 140 acquires each of the plurality of pieces of unknown data stored in the document data memory unit 210. The partial data generation unit 140 divides each of the plurality of pieces of the acquired unknown data into partial unknown data which constitute part of each piece of the unknown data.

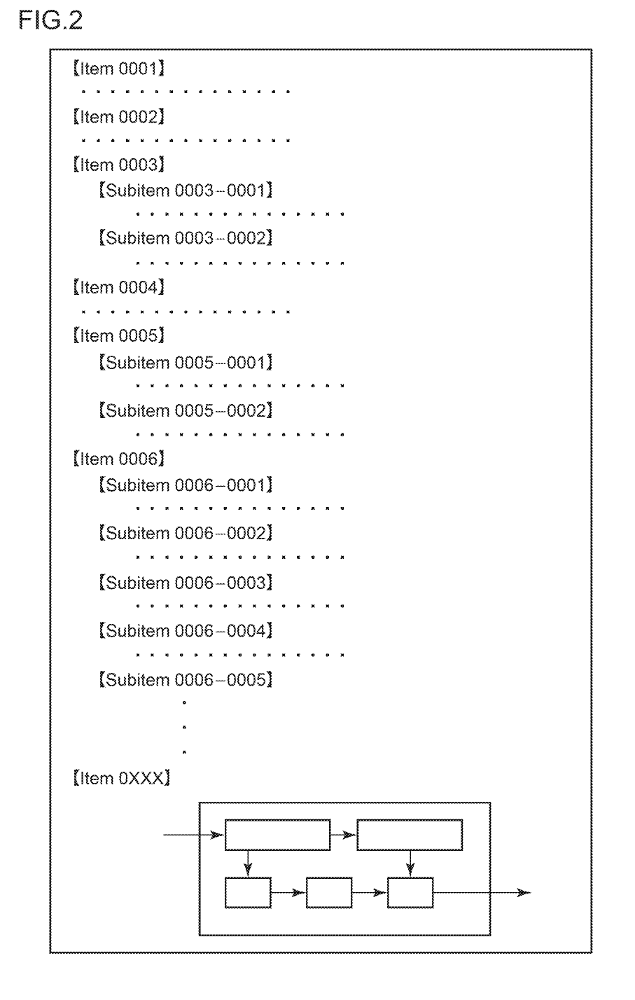

FIG. 2 is a diagram schematically illustrating the format of the unknown data. Generally, a patent document or technical paper is document data created according to a predetermined format including a plurality of items as illustrated in FIG. 2 and is divided by each item. Furthermore, some items may be further divided into subitems. Each item or each subitem includes a group of texts, diagrams, charts, and so on. For example, in a case of a description of a patent document, the description is divided by numbers representing paragraph numbers into a plurality of paragraphs and each paragraph includes texts. Furthermore, documents illustrating diagrams are divided by numbers representing figure numbers into some items and each item includes a diagram. Under this circumstance, the text included in each item according to the predetermined format is unstructured data (data whose structure definition is at least partially incomplete).

Incidentally, in this description, “documents” or “document data” include not only character data such as texts and mathematical expressions, but also graphic data such as diagrams, charts, and chemical formulas. For example, such “documents” or “document data” include patent documents, technical papers, e-mails, presentation materials, spreadsheet materials, meeting materials, contracts, organization charts, business plans, and so on. Furthermore, scan data can be also treated as documents. In this case, an OCR (Optical Character Reader) device may be included in a document judgment system so that the scan data can be converted into text data. Keywords and related terms can be analyzed and searched from the scan data by changing the scan data to the text data by using the OCR device.

The partial data generation unit 140 divides the unknown data by using the items included in the unknown data as units. The partial data generation unit 140 generates each piece of data obtained by dividing the unknown data, as partial unknown data. Incidentally, the units based on which the partial data generation unit 140 generates the partial unknown data are not limited to the items. For example, when a certain item includes a text, the partial data generation unit 140 may generate the partial unknown data by setting one sentence as a unit or generate the partial data by setting a sentence(s) included from a line break to the next line break as a unit.

The data evaluation unit 150 acquires the evaluation results by the relation evaluation unit 120 which are stored in the evaluation memory unit 220 in the memory unit 200. The data evaluation unit evaluates each piece of the partial unknown data generated by the partial data generation unit 140 on the basis of the acquired evaluation results. More specifically, the data evaluation unit 150 calculates a score indicating the relation between each piece of the partial unknown data generated by the partial data generation unit 140 and the classification information on the basis of the evaluation results stored in the evaluation memory unit 220 in the memory unit 200. The score is calculated by the data evaluation unit 150 so that when the relation between the data elements included in the partial unknown data and the classification information is strong, the value of the score becomes larger than a case when the relation between the data elements included in the partial unknown data and the classification information is weak.

The output unit 170 outputs the score calculated by the data evaluation unit 150 to the user. The score calculated by the data evaluation unit 150 evaluates the partial unknown data so that when the relation between the partial unknown data and the classification information is strong, the score indicates higher evaluation than a case where the relation is weak.

When the data analysis system 1 includes a monitor (which is not illustrated in the drawing), the output unit 170 may output the score calculated by the data evaluation unit 150 together with the corresponding partial unknown data or an identifier for identifying the partial unknown data (for example, the paragraph number and the patent document number) to the monitor. When the data analysis system 1 is connected to a network such as a LAN (Local Area Network) or WAN (Wide Area Network), the output unit 170 may transmit the above-described score and identifier to the user via the network. Alternatively, when the data analysis system 1 includes a printer (which is not illustrated in the drawing), the output unit 170 may output the above-described score and identifier via the printer.

Next, the specified standards to which the relation evaluation unit 120 refers will be briefly explained.

The relation evaluation unit 120 calculates the score indicating the strength of the relation between the data elements of data included in the training data and the classification information. The data elements are sets of character strings with certain meanings in a certain language as described earlier and are so-called “keywords.” For example, when the data elements are selected from a sentence reciting that “documents are analyzed chronologically,” “documents,” “chronologically,” and “analyzed” may be selected

When the data elements “documents,” “chronologically,” and “analyzed” extracted from the sentence reciting that “documents are analyzed chronologically” are evaluated as “0.1,” “2.2,” and “1.9” respectively by the relation evaluation unit 120, the score calculation unit 180 calculates, for example, the score of the relevant text data as 0.1+2.2+1.9=4.2.

More specifically, the score calculation unit 180 generates an element vector indicating whether a specified data element is included in data (for example, the unknown data or the partial unknown data) or not. The above-mentioned element vector is a vector indicating whether or not a specified data element associated with each element of the element vector is included in the relevant data as each element of the element vector takes the value of “0” or “1.” For example, when a data element “analysis system” is included in the data, the score calculation unit 180 changes an element of the element vector corresponding to the “analysis system from “0” to “1.” Then, the score calculation unit 180 calculates score S of the data by calculating an inner product between the element vector (column vector) and a weight vector (column vector using the weight for each data element [the evaluation result of the relation evaluation unit 120] as its element) according to the following formula.

S=w^{T}·s [Math. 1]

In the above expression, s represents the element vector and W represents the weight vector. It should be noted that T means matrix-vector transposition (switching columns with rows).

Alternatively, the score calculation unit 180 may calculate the score S according to the following formula.

$$S = \frac{{\sum }_{j = 0}^{N} {jm}_{j} {w}_{j}^{2}}{{\sum }_{i = 0}^{N} {iw}_{i}^{2}} \qquad [ Math . 2 ]$$

In the above expression, mⱼ represents appearance frequency of a j-th data element and wᵢ represents the weight of an i-th data element.

Alternatively, the score calculation unit 180 may calculate the score on the basis of the evaluation result of a first data element included in the training data (the weight of the first data element) and the evaluation result of a second data element included in the relevant learning data (the weight of the second data element). Specifically speaking, when the first data element appears in the learning data, the score calculation unit 180 can calculate the score in consideration of appearance frequency of the second data element in the relevant data (which can be also referred to as the correlation or co-occurrence between the first data element and the second data element). Consequently, the data analysis apparatus 100 can calculate the score in consideration of the correlation between the data elements, so that the unknown data related to the training data can be extracted with higher accuracy.

The data evaluation unit 150 evaluates the relation between each piece of the partial unknown data and the training data on the basis of the evaluation results by the relation evaluation unit 120. Consequently, when the relation between the partial unknown data and the training data is strong, the data evaluation unit 150 can calculate the score so that the value of the score becomes larger than the case where the relation is weak.

Under this circumstance, for example, when the data analysis system 1 is applied to the invalid material search, patent documents may be often adopted as the unknown data. When the unknown data are the patent documents, it is assumed in consideration of the respective items such as abstracts, descriptions, claims, and drawings which are generally included in the patent documents that the partial data generation unit 140 may divide each piece of the unknown data into about 100 pieces of the partial unknown data. In this case, regarding the score calculated by the data evaluation unit 150, about 100 scores may be calculated for one piece of the unknown data.

So, the evaluation integration unit 160 generates an integrated score which integrates the scores calculated by the data evaluation unit 150 with respect to the partial unknown data obtained by breaking down the unknown data. Specifically speaking, the evaluation integration unit 160 may generate the integrated score, which is obtained with respect to each piece of the unknown data by integrating the scores calculated by the data evaluation unit 150 with respect to each piece of the partial unknown data obtained by breaking down the unknown data, as an integrated index.

After the output unit 170 notifies the user of the data elements which are judged by the data analysis apparatus 100 that they are related to the data elements in the training data, the relation evaluation unit 120 can receive feedback on the judgment from the user via a user interface which is not illustrated in the drawing. Specifically speaking, the user can input whether each result of the judgment by the data analysis apparatus 100 is reasonable or not, as the feedback.

Incidentally, the relation evaluation unit 120 can reevaluate each data element according to the feedback. Specifically speaking, the relation evaluation unit 120 calculates the weight of each data element according to the following format.

$${w}_{i , L} = \sqrt{{w}_{i , L}^{2} + {γ}_{L} {w}_{i , L}^{2} - ϑ} = \sqrt{{w}_{i , L}^{2} + {\sum }_{l = 1}^{L} ( {γ}_{l} {w}_{i , l}^{2} - ϑ )} \qquad [ Math . 3 ]$$

In the above expression, w_{i,L} represents the weight of the i-th data element after L-th learning, γ_{L} represents a learning parameter for L-th learning, and θ represents a threshold value of learning effects.

Specifically speaking, the relation evaluation unit 120 can recalculate the weight according to the newly obtained feedback on the judgment by the data analysis apparatus 100. As a result, the data analysis apparatus 100 can acquire appropriate weight for the analysis target data and calculate the score accurately on the basis of the weight, so that the data elements of the unknown data which are related to the data elements of the training data can be extracted with higher accuracy.

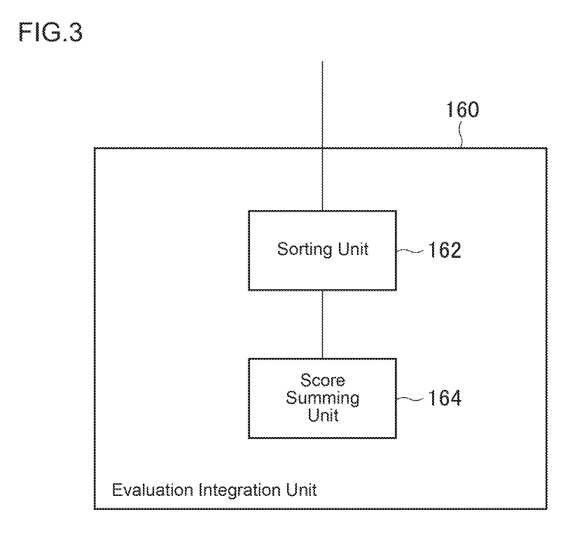

FIG. 3 is a diagram for schematically illustrating an internal configuration of the evaluation integration unit 160 according to the embodiment. The evaluation integration unit 160 according to the embodiment includes a sorting unit 162 and a score summing unit 164.

Generally, when the patent invalid material search or the prior art search is performed, disclosure items having a strong relation with the training data are rarely found through one entire document. In many cases, disclosure items having a strong relation with the training data are found in some paragraphs or in some pieces of the partial unknown data in the entire document data. Therefore, even if the scores for most of the partial unknown data included in certain unknown data are small values, it may be judged that the relevant unknown data has a strong relation with the training data when the scores for a small number of pieces of the partial unknown data are large.

So, the sorting unit 162 sorts the evaluation results by the data evaluation unit 150 on the partial unknown data obtained by breaking down the unknown data, for example, in descending order with respect to each piece of the unknown data. The score summing unit 164 generates, as the integrated score, a value obtained by summing a specified number of the scores sorted by the sorting unit 162 in descending order.

Under this circumstance, the “specified number” means a reference addition number of each piece of partial unknown data to which the score summing unit 164 refers when generating the integrated score. The “specified number” may be determined according to experiments in consideration of a target event to which the data analysis system 1 is applied; however, the “specified number” may be, for example, “10.” When the specified number is 10, the score summing unit 164 generates, as the integrated score, a value obtained by summing ten scores of the partial unknown data included in the relevant unknown data in descending order with respect to each piece of the unknown data.

Incidentally, the specified number is not limited to 10. For example, if the specified number is 1, the score summing unit 164 calculates the maximum score, from among the scores of the partial unknown data included in each piece of the unknown data, as the integrated score of that unknown data. Furthermore, if the “number of items of each piece of the unknown data” is set as the specified number, the score summing unit 164 may calculate the total sum of the scores of the partial unknown data included in each piece of the unknown data as the integrated score. In this case, in order to absorb differences in the number of pieces of the partial unknown data included in each piece of the unknown data, the score summing unit 164 may calculate, as the integrated score, a value obtained by dividing the total sum of the scores of the partial unknown data included in each piece of the unknown data by the number of pieces of the partial unknown data, that is, an average value of the scores of the partial unknown data.

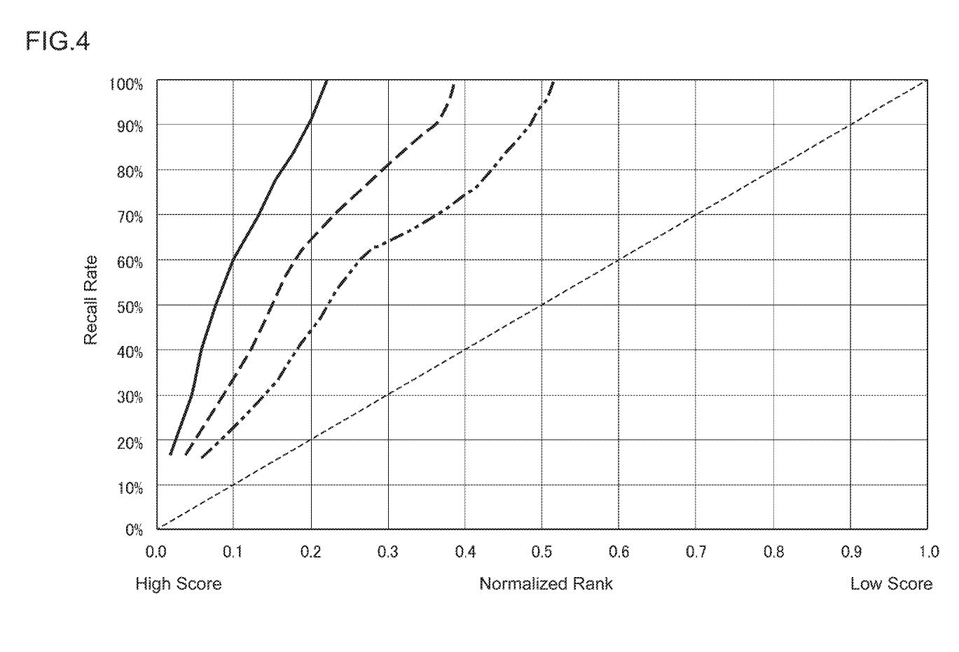

FIG. 4 is a graph indicating the evaluation results of performance of the data analysis system 1 according to the embodiment and is a graph indicating the results of applying the data analysis system 1 to the patent invalidity searches. The horizontal axis of the graph represents a normalized rank (the rank by which the descending order of scores calculated for the unknown data is normalized within the range of 0 to 1) and the vertical axis represents a recall rate (an index indicative of comprehensiveness of the extracted data). In an example illustrated in FIG. 4, the data analysis system 1 learns by using each piece of learning data which are prepared by extracting (1) statements of patent claims in a given registered patent and (2) descriptions of several hundreds of patent documents which are randomly extracted from several thousands of unknown patent documents, associating a correct label (classification information) with the above item (1), and associating an incorrect label (classification information) with the above item (2). In the example of the recall rate illustrated in FIG. 4, the horizontal axis represents the normalized rank regarding which the normalization is performed so that the integrated score generated by the evaluation integration unit 160 falls within the range of 0.0 to 1.0. A smaller value of this normalized rank represents a stronger relation (that is, a higher score).

In the example illustrated in FIG. 4, a graph indicated with a solid line shows an example where the score summing unit 164 generates, as the integrated score, a value obtained by summing ten scores of the partial unknown data included in the unknown data in descending order with respect to each piece of the unknown data (hereinafter referred to as “Example 1”). Furthermore, a graph indicated with a dashed line in FIG. 4 shows an example where the score summing unit 164 calculates the maximum score, among the scores of the partial unknown data included in each piece of the unknown data, as the integrated score of that unknown data (hereinafter referred to as “Example 2”). Furthermore, a graph indicated with a two-dot chain line in FIG. 4 shows an example where the data evaluation unit 150 evaluates the unknown data without dividing it into partial unknown data (hereinafter referred to as “Example 3”).

Regarding Example 2 as illustrated in FIG. 4, all the invalid materials are found when the normalized rank is approximately slightly less than 0.4. Specifically speaking, it is shown that when several thousands of pieces of unknown data are sorted according to the normalized rank, all the invalid materials are included in approximately slightly less than top 40%. Regarding Example 1, all invalid materials are found when the normalized rank is slightly over 0.2. Specifically speaking, it is shown that when several thousands of pieces of unknown data are sorted according to the normalized rank, all the invalid materials are included in approximately top 20%. FIG. 4 shows that the performance of the data analysis system 1 improves by using the total sum of the top 10 scores as the integrated score rather than adopting the maximum value of the score of the partial unknown data as the integrated score.

Furthermore, regarding Example 3, all the invalid materials are found when the normalized rank is approximately 0.5. Specifically speaking, it is shown that all the invalid materials start appearing only after searching half of several thousands of pieces of the unknown data.

Manual search of invalid materials will be examined. Let us assume that it takes an average time of 30 seconds for a person to visually check one patent document and judge whether that document is related to the statements of the given patent claims or not. In this case, for example, 2500 minutes (approximately 1.7 days) of time are required to search all 5000 patent documents. Naturally, when a person performs the invalid material search, they need break time. So, they actually need more time. Also, when a plurality of persons split up and performs the invalid material search, the judgment standards may vary depending on the persons.

The data analysis system 1 according to the embodiment judges the relation to the training data (that is, the statements of claims targeted for nullification) according to the same standards with respect to all the pieces of unknown data on the basis of the evaluation results of the relation evaluation unit 120. Accordingly, it is possible to suppress misjudgment on the relation with respect to the documents as compared to the manual search. Furthermore, the documents to be searched for approximately 5 minutes can be reduced by 20% to 40% by using the data analysis system 1. Therefore, it is possible to considerably reduce burdens on the user for the patent search.

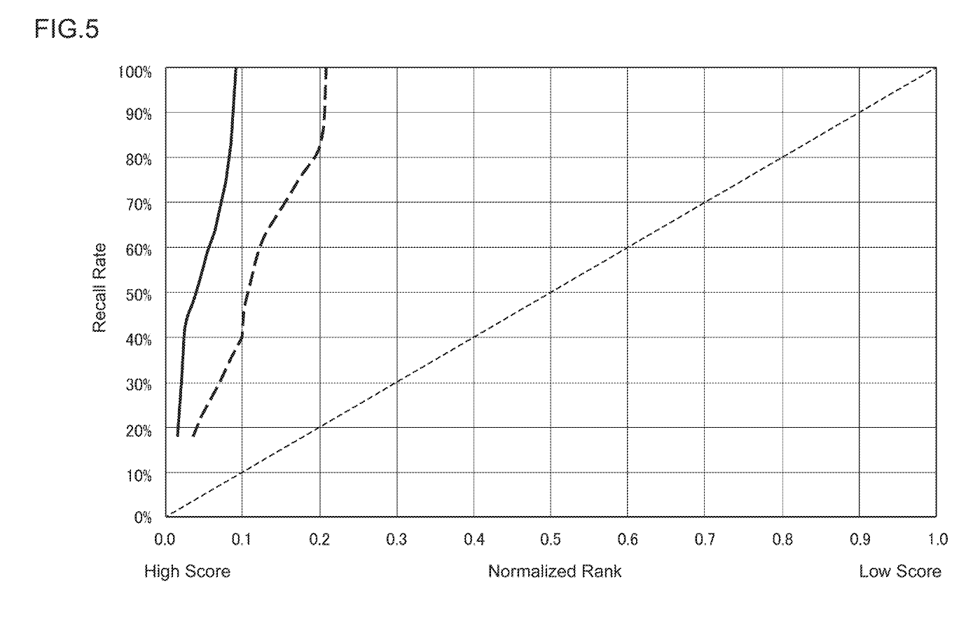

FIG. 5 is a graph indicating the evaluation results of performance of the data analysis system 1 according to the embodiment and is a graph indicating the results of applying the data analysis system 1 to the prior art search. An example illustrated in FIG. 5 shows a recall rate when abstracts of inventions which are prepared by the user in advance and are targeted for the prior art search are used as correct data and several hundreds of patent documents randomly extracted from several thousands of unknown patent documents are used as incorrect data. Several prior art documents which are manually extracted in advance are included in the several thousands of unknown patent documents.

In the example illustrated in FIG. 5, a graph indicated with a solid line shows an example where the score summing unit 164 generates, as the integrated score, a value obtained by summing ten scores of the partial unknown data included in the unknown data in descending order with respect to each piece of the unknown data (hereinafter referred to as “Example 4”). Furthermore, a graph indicated with a dashed line in FIG. 4 shows an example where the score summing unit 164 calculates the maximum score, among the scores of the partial unknown data included in each piece of the unknown data, as the integrated score of that unknown data (hereinafter referred to as “Example 5”).

Regarding Example 5 as illustrated in FIG. 5, all the several prior art documents appear when the normalized rank is approximately slightly less than 0.2. Specifically speaking, it is shown that when several thousands of pieces of unknown data are sorted according to the normalized rank, all the prior art documents are included in approximately slightly less than top 20%. Regarding Example 4, all the several prior art documents are found when the normalized rank is approximately 0.1. Specifically speaking, it is shown that when several thousands of pieces of unknown data are sorted according to the normalized rank, all the prior art documents are included in approximately top 10%. FIG. 4 and FIG. 5 show that the performance of the data analysis system 1 improves by using the total sum of the top 10 scores as the integrated score rather than adopting the maximum value of the score of the partial unknown data as the integrated score. However, in any event, it impossible to considerably reduce burdens on the user with respect to the prior art documents.

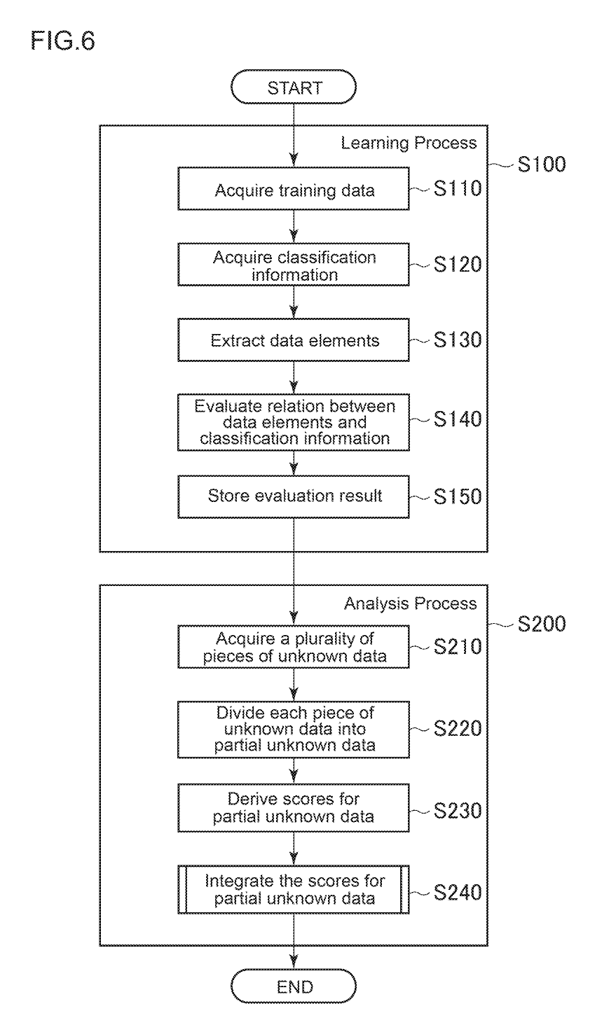

FIG. 6 is a flowchart for explaining a flow of data analysis processing executed by the data analysis apparatus 100 according to the embodiment. The processing of this flowchart starts when, for example, the data analysis apparatus 100 is activated.

The data analysis processing executed by the data analysis apparatus 100 according to the embodiment is mainly divided into a learning process S100 and an analysis process S200. Firstly, in the learning process S100, the relation between data elements of the training data and the classification information is evaluated. Then, in the analysis process S200, the relation to the training data is analyzed with respect to each of the plurality of pieces of unknown data, which are analysis targets, on the basis of the evaluation results of the learning process S100. The learning process S100 and the analysis process S200 will be respectively explained below in more detail.

The learning process S100 includes data acquisition steps S110, S120, a data element extraction step S130, a relation evaluation step S140, and an evaluation storage step S150 which will be explained below.

The data acquisition unit 110 acquires the training data (S110). The data acquisition unit 110 also acquires the classification information for classifying the training data (S120). Combinations of the training data and the classification information which are acquired by the data acquisition unit 110 constitute a training data set.

The relation evaluation unit 120 extracts the data elements included in the training data acquired by the data acquisition unit 110 (S130). The relation evaluation unit 120 also evaluates the relation between each extracted data element and the classification information (S140). The evaluation storage unit 130 associates the evaluation results of the relation evaluation unit 120 with the evaluated data elements and stores them in the evaluation memory unit 220 in the memory unit 200 (S150). Reference is made to the evaluation results stored in the evaluation memory unit 220 by the evaluation storage unit 130 during the analysis process S200.

The analysis process S200 includes a data acquisition step S210, an unknown data generation step S220, a data evaluation step S230, and a score integration step S240.

The data acquisition unit 110 acquires the plurality of pieces of unknown data stored in the document data memory unit 210 (S210). The partial data generation unit 140 divides each of the plurality of pieces of unknown data acquired by the data acquisition unit 110 into partial unknown data which constitute each piece of the unknown data (S220). The data evaluation unit 150 calculates the score indicating the relation between each piece of the partial unknown data and the training data on the basis of the evaluation results stored in the evaluation memory unit 220 in the memory unit 200 (S230). The evaluation integration unit 160 generates the integrated score with respect to each piece of the unknown data by integrating the scores calculated by the data evaluation unit 150 with respect to the partial unknown data obtained by breaking down the unknown data (S240).

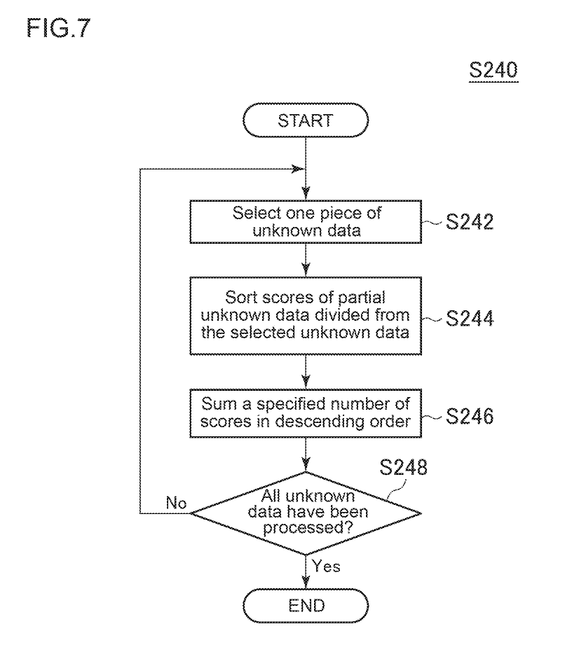

FIG. 7 is a flowchart for explaining a flow of integrated score generation processing executed by the evaluation integration unit 160 according to the embodiment and is a diagram for explaining the processing of the score integration step S240 in FIG. 6 in more detail. The integrated score generation processing executed by the evaluation integration unit 160 includes an unknown data selection step S242, an index sorting step S244, and a score summing step S246.

The sorting unit 162 selects one piece of the unknown data from among the unknown data stored in the document data memory unit 210 (S242). The sorting unit 162 sorts the scores evaluated by the data evaluation unit 150 in descending order or ascending order with respect to the partial unknown data obtained by dividing the selected unknown data (S244).

The score summing unit 164 sums a specified number of scores sorted by the sorting unit 162 in descending order and sets the obtained score as the integrated score (S246). Until the sorting unit 162 completes selecting all pieces of the unknown data stored in the document data memory unit 210 (No in S248), the processing of the unknown data selection step S242, the index sorting step S244, and the score summing step S246 which are described above is continued. When the sorting unit 162 finishes selecting all pieces of the unknown data stored in the document data memory unit 210 (Yes in S248), the processing of this flowchart terminates.

The data analysis system according to the embodiment as described above learns, as learning data, data including the training data, which is the purpose of the search, and the specified number of pieces of the unknown data acquired from the plurality of pieces of unknown data which are the search targets. In this learning process, the relation evaluation unit 120 evaluates the relation between the data elements in the training data and the data elements in the unknown data, associates the evaluated data elements with each other, and stores them in the memory unit 200. The score indicating the relation to the training data with respect to the plurality of pieces of unknown data is calculated by using the evaluation results. As a result, it is possible to analyze the unknown data mechanically according to certain standards and support finding of data related to data in which specific ideas, events, etc. are described from a large amount of unknown data.

Particularly, the patent invalid material searches and the prior art searches before filing of patent applications are assumed to be main objects to which the data analysis system 1 according to the embodiment is applied. The patent documents are generally document data created according to a predetermined format including a plurality of items such as paragraphs and patent claims. The partial data generation unit 140 divides the unknown data on the basis of the items in the patent documents and thereby generates the partial unknown data. As a result, it is possible to perform the analysis by utilizing the structure of the analysis target data and enhance the accuracy of the data analysis.

### [Supplement]

The present invention is not limited to each of the aforementioned embodiments and various changes can be made to the invention within the scope stated in the claims, and embodiments obtained by appropriately combining technical means respectively disclosed in different embodiments are also included in the technical scope of the present invention. Furthermore, a new technical feature can be formed by combining the technical means disclosed in the respective embodiments.

With the data analysis system 1 according to an aspect of the present invention, the relation evaluation unit 120 can evaluate data elements by using an index (for example, a transmitted information amount) representing a dependency relation between the data elements and the judgment result made by the user on data which have been already judged including the relevant data elements (the classification information) as one of the specified standards.

The data analysis system 1 according to an aspect of the present invention: sets right holder identification information indicating to which one(s) of applicants, right holders, inventors, and authors of the unknown data (hereinafter referred to as the “right holder(s)”) are related; designates the right holder; searches for a specified file to which the right holder identification information corresponding to the designated right holder is set; sets accessory information indicating whether or not the specified file found by the search is related to a technique which is the purpose of the search; and outputs the specified file related to the technique which is the purpose of the search on the basis of the accessory information.

The data analysis system 1 according to an aspect of the present invention: accepts input of a categorization sign(s) from the user in order to assign the categorization sign(s) indicating the relation to the technique which is the purpose of the search (that is, the technique described in the training data) with respect to the data; categorizes the data by each categorization sign; analyzes and selects data elements which appear in the categorized data in common with each other; searches the data for the selected data elements; calculates a score indicating the relation between the categorization sign and the data by using the search results and the analysis results of the data elements; and assigns the categorization sign to the data on the basis of the calculated score.

Regarding the data analysis system 1 according to an aspect of the present invention, (1a) categorization sign (classification information) A, (1b) data elements included in data to which categorization sign A is assigned, (1c) data element correspondence information indicating the correspondence relationship between categorization sign A and the data elements, (2a) categorization sign B, (2b) related data elements with high appearance frequency in data to which categorization sign B is assigned, (2c) related data element correspondence information indicating the correspondence relationship between categorization sign B and the related data elements are stored in the memory unit 200. The data analysis system 1: assigns categorization sign A to the data including the above-mentioned data elements (1b) on the basis of the above-mentioned data element correspondence information (1c); extracts data including the above-mentioned related data elements (2b) from data to which the categorization sign A has not been assigned; calculates a score based on evaluation values and the number of the related data elements; assigns categorization sign B to data whose score exceeds a certain value on the basis of the score and the above-mentioned related data element correspondence information (2c); and accepts the assignment of categorization sign C from the user to data to which the categorization sign B has not been assigned.

The data analysis system 1 according to an aspect of the present invention registers data elements for judging whether or not data is related to the technique which is the user's purpose of the search, in a database; searches the data for the data elements registered in the database; extracts sentences including the searched data elements from the data; calculates a score indicating the degree of relevance to the technique, which is the purpose of the search, according to a feature quantity extracted from the extracted sentences; and changes the emphasis degree of the sentences according to the score.

The data analysis system 1 according to an aspect of the present invention: records the judgment result of the relation to the technique which is the purpose of the search by the user or a progress speed of the relation judgment as actual result information; generates predicted information about the result or the progress speed; compares the actual result information with the predicted information; and generates an icon for presenting the evaluation of the relation judgment by the user on the basis of the comparison result.

The data analysis system 1 according to an aspect of the present invention: accepts input from the user with respect to result information indicating the relation between the technique which is the purpose of the search, and the unknown data; calculates an evaluation value of a common data element(s), which appears in the data, with respect to each piece of the result information on the basis of characteristics of the data elements; selects the data element on the basis of the evaluation value; calculates a score of the data from the selected data element and its evaluation value; and calculates the recall rate based on the score.

The data analysis system 1 according to an aspect of the present invention: displays data to the user; accepts identification information (tag) which is assigned to review object data on the basis of a judgment on whether or not the data is related to the technique which is the purpose of the search by the user; compares the feature quantity of the object data regarding which the tag is accepted, with the feature quantity of the data; updates a score of the data corresponding to a specified tag on the basis of the comparison result; and controls the order to display the data to be displayed on the basis of the updated score.

When a source code is updated, the data analysis system 1 according to an aspect of the present invention: records the updated source code; creates an executable file from the recorded source code; executes the executable file for the purpose of verification; transmits the executed verification result; and has a server receive the distributed verification result. Incidentally, the source code can be implemented by using, for example, a script language such as Ruby, Perl, Python, ActionScript, or JavaScript (registered trademarks), or an object-oriented programming language such as C++, Objective-C, or Java (registered trademarks), or a markup language such as HTML5.

The data analysis system 1 according to an aspect of the present invention: displays data for judging the relation to the technique which is the purpose of the search by the user, and a classification button for having the user select classification conditions to classify the data; accepts information about the classification button selected by the user as selected information; classifies the data according to the analysis result of the data based on the selected information; and displays the data on the basis of the classification result.

The data analysis system 1 according to an aspect of the present invention: checks each piece of accessory information of voice and image data; classifies the voice and image data on the basis of the accessory information; extracts elements included in the accessory information of the classified voice and image data; analyzes similarity on the basis of the extracted elements; and performs integration and analysis based on the similarity. Incidentally, the voice data may be converted into character information by using known voice recognition technology.

The data analysis system 1 according to an aspect of the present invention: extracts a passworded file(s) which is protected with a password; inputs a candidate word to the passworded file by using a dictionary file in which candidate words that are candidates for the password are registered; and receives the result of judgment on the relation to the technique which is the purpose of the search by the user with respect to the file whose password has been unlocked.

The data analysis system 1 according to an aspect of the present invention: divides data of search target files of a binary format into a plurality of blocks; searches the search target files of the binary format for data of the blocks; and outputs the search result.

The data analysis system 1 according to an aspect of the present invention: selects target digital information which is a search target; stores a combination of a plurality of words having the relation to a specific matter; performs a search to check whether or not the stored combination of the plurality of words is included in the selected target digital information; and judges the relation between the target digital information and the specific matter on the basis of the result of morpheme analysis if the stored combination of the plurality of words is included in the selected target digital information; and associates the judgment result with the target digital information.

The data analysis system 1 according to an aspect of the present invention: extracts image groups and voice groups from image information and voice information; accepts input of categorization signs from the user in order to assign the categorization signs to the image groups and the voice groups; categorizes the image groups and the voice groups by each categorization sign; analyzes and selects a common element(s) which appears in the categorized image groups and voice groups; searches the image information and the voice information for the selected data element; calculates a score by using the search result and the analysis result of the data element; assigns the categorization sign to the image information and the voice information on the basis of the calculated score; displays the calculation result of the score and the categorization result on a screen; and calculates the number of images and the number of voices which are required for recheck on the basis of the relationship between the recall rate and the normalized rank.

Regarding the data analysis system 1 according to an aspect of the present invention, (1a) categorization sign A, (1b) data elements included in data to which categorization sign A is assigned, (1c) data element correspondence information indicating the correspondence relationship between categorization sign A and the data elements, (2a) categorization sign B, (2b) related data elements with high appearance frequency in data to which categorization sign B is assigned, (2c) related data element correspondence information indicating the correspondence relationship between categorization sign B and the related data elements are stored in the memory unit 200. The data analysis system 1: assigns categorization sign A to the data including the above-mentioned data elements (1b) on the basis of the above-mentioned data element correspondence information (1c); extracts data including the above-mentioned related data elements (2b) from data to which the categorization sign A has not been assigned; calculates a score based on evaluation values and the number of the related data elements; assigns categorization sign B to data whose score exceeds a certain value on the basis of the score and the above-mentioned related data element correspondence information (2c); accepts the assignment of categorization sign C from a doctor to data to which the categorization sign B has not been assigned; analyzes the data to which categorization sign C is assigned; and assigns categorization sign D to data to which no categorization sign is assigned, on the basis of the analysis result.

The data analysis system 1 according to an aspect of the present invention calculates a score indicating the relation to the technique which is the purpose of the search, with respect to each piece of the partial unknown data. The data analysis system 1: extracts data based on the calculated score in a specified order; accepts categorization signs which are assigned to the extracted data on the basis of the relation to the technique which is the purpose of the search by the user; categorizes the extracted data by each categorization sign on the basis of the categorization signs; analyzes and selects common data elements which appear in the categorized data; searches the data for the selected data elements; and recalculates a score for each piece of data by using the search result and the analysis result.

Regarding the data analysis system 1 according to an aspect of the present invention, information relating to the technique which is the purpose of the search is stored in an basic search database (which is not illustrated in the drawing); and the data analysis system 1 accepts input of a category of the technique which is the purpose of the search, judges a search category which is a search target on the basis of the accepted category, and extracts necessary information type from the basic search database.

The data analysis system 1 according to an aspect of the present invention: collects case search results including categorization work results for each case with respect to the technique which is the purpose of the search; registers search model parameters for performing a search regarding the technique which is the purpose of the search; searches for the registered search model parameters when the search content of a new search case is input; extracts the search model parameter related to input information; outputs a search model by using the extracted search model parameter; and configures prior information to perform a search for the new search case based on the search model output result.

The data analysis system 1 according to an aspect of the present invention: acquires information about a right holder(s); acquires updated digital information on the basis of that information at regular time intervals; organizes a plurality of files, which constitute the acquired digital information, in a specified storage place on the basis of recording place information, file names, and metadata regarding the acquired digital information; and creates a status distribution by visualizing the status of the plurality of organized files so that the status of the right holder who has accessed the digital information can be recognized. The information about the right holder(s) includes, for example, newly published patent applications of the right holder(s), information about their newly registered patent rights, and information about their newly published papers.

The data analysis system 1 according to an aspect of the present invention: acquires metadata related to digital information; updates a weighted parameter set based on the relation between first digital information, which has a relation with a specific matter, and the metadata; and updates the relation between morphemes and the digital information by using the weighted parameter set.

The data analysis system 1 according to an aspect of the present invention: accepts a categorization sign which is manually assigned to object data; calculates a relation score of the object data; judges whether the categorization sign is correct or wrong, on the basis of the relation score; and determines a categorization sign to be assigned to the object data on the basis of the correct/wrong judgment result.

The data analysis system 1 according to an aspect of the present invention: accepts input of a category to which the technique that is the purpose of the search belongs; performs a search based on the accepted category; prepares a report in order to report the search results; stores information related to the technique which is the purpose of the search in the basic search database; judges a search category which is the search target, on the basis of the accepted category; extracts a necessary information type from the basic search database; presents the extracted information type to a doctor; accepts input of data elements to be used from the doctor to assign a categorization sign corresponding to the presented information type; and automatically assigns the categorization sign to the data.

The data analysis system 1 according to an aspect of the present invention: acquires published information of a subject; analyzes the published information; outputs external elements of the subject; stores a behavior occurrence model based on behavioral external elements of a behavioral subject who performed a specific action; extracts and stores behavioral factors which fit the behavior occurrence model from the external elements of the subject; acquires internal information of the subject; analyzes the internal information; outputs the internal elements of the subject; and automatically identifies an analysis target based on similarity between the internal elements and the behavioral factors.

The data analysis system 1 according to an aspect of the present invention: acquires relation information indicating the relation between digital information and a specific matter; calculates a relation score, which is determined according to the relation between the digital information and the specific matter, with respect to each piece of the digital information; calculates a ratio of the number of pieces of the relation information assigned to the digital information included in a specified range of the relation score to a total number of pieces of the digital information having the relation score included in each range with respect to each specified range of the relation score; and displays a plurality of sections associated with the respective ranges by changing the hue, brightness, or color intensity on the basis of the ratio.

The data analysis system 1 according to an aspect of the present invention: calculates a score indicating strength of linkage between data and a categorization sign in a time-series manner; detects chronological changes in the score from the calculated score; and examines and judges the relevance between a search case and extracted data on the basis of the result of judgment of time when the score changes in excess of a specified reference value when judging the detected chronological changes in the score.

The data analysis system 1 according to an aspect of the present invention: stores weighting information associated with a plurality of data elements having the relation to a specific matter and including co-occurrence expressions; associates a score with digital information; extracts sample digital information which becomes samples from the digital information on the basis of the score; and updates the weighting information by analyzing the extracted sample digital information.

The data analysis system 1 according to an aspect of the present invention: selects a category which is an index capable of classifying each piece of data included in a plurality of pieces of data; and calculates a score for each category.

The data analysis system 1 according to an aspect of the present invention: identifies a phase for classifying the technique which is the purpose of the search according to the progress of the relevant specified action (for example, the status of patent examinations or the status of claim amendments or corrections) on the basis of a score; and estimates changes in the specified phase on the basis of temporal transitions of the phase.

When verbs expressing operations are included in voices, the data analysis system 1 according to an aspect of the present invention: identifies objects which represent targets of the operations; associates metadata, which represents attributes of the voices including the verbs and the objects, with the verbs and the objects; evaluates the relation with the voices and symptoms on the basis of the association; and displays the relationship of a plurality of persons related to the symptoms.

The data analysis system 1 according to an aspect of the present invention: calculates a score indicating strength of linkage between data included in a data group and a categorization sign indicating the relevance between the data group and the technique which is the purpose of the search; reports the calculated score to the user according to the calculated score; and outputs a research report according to a research type of the technique which is the purpose of the search (for example, types such as the invalidity search and the prior art search).

The data analysis system 1 according to an aspect of the present invention: generates a data element vector indicating whether or not a specified data element is included in sentences contained in data (for example, texts of claims), with respect to each sentence; obtains a correlation vector for each sentence by multiplying the data element vector by a correlation matrix indicating the correlation between the specified data element and other data elements; and calculates a score based on a value obtained by summing all correlation vectors.

The data analysis system 1 according to an aspect of the present invention: learns weighting of data elements included in categorized data, regarding which whether it is related to the technique which is the purpose of the search is categorized by the user; searches uncategorized data, regarding which whether it is related to the technique which is the purpose of the search or not has not been categorized by the user, for data elements included in the categorized data; calculates a score that evaluates the strength of linkage between the uncategorized data and categorization signs by using weighting of the searched data elements and the learned data elements. Under this circumstance, the data analysis system 1 can extract a concept which can summarize data (ontology). For example, the data analysis system 1 can: create a database, in which keywords of subordinate concepts are mapped to their corresponding object concepts, respectively, with respect to each selected object concept, by analyzing the training data; execute morpheme analysis on data (such as the unknown data and the partial unknown data); and extract the object concepts corresponding to the content of the relevant data with reference to the above-mentioned database. Accordingly, even if data elements constituting the training data and data elements constituting the unknown data (or the partial unknown data) are different from each other, the data analysis system 1 can highly evaluate the relevant unknown data (or the partial unknown data) (that is, the data evaluation in consideration of meanings and concepts included in the data can be performed) as long as both of their concepts are in common with each other. Furthermore, the data analysis system 1 may cluster the data on the basis of the extracted results and present the entire picture (summary) of the classification results to the user.

The above-described embodiments have described examples where the data analysis system 1 is implemented as a “patent search system” (that is, examples where the analysis target of the data analysis system 1 is patent documents, etc.); however, the data analysis system 1 can be applied to the following examples.

Furthermore, the data analysis system 1 can be also applied to an Internet application system. In this case, the Internet application system evaluates the relation between the training data (such as messages posted by the user on an SNS, information of recommendations posted on web sites, and the user or organization's profile information) and the classification information indicating a specified case (for example, when the relevant user's tastes are similar to another user's tastes, or when the relevant user's tastes match restaurants' attributes) and can thereby, for example, display a list of other users who might get along with the relevant user, present information of restaurants which would suit the user's tastes, or give a warning about organizations which might possibly cause harm to the user. As a result, the Internet application system (the data analysis system 1) can enhance the user-friendliness of the Internet.

Furthermore, the data analysis system 1 can be also applied to a driving support system. In this case, the driving support system evaluates the relation between the training data (such as data obtained from, for example, a car-mounted sensor, a camera, and a microphone) and the classification information indicating a specified case (such as information to which an experienced driver paid attention while the experienced driver was driving a car) and can thereby, for example, automatically extract useful information which can make driving safe and comfortable.

Furthermore, the data analysis system 1 can be also applied to a financial system. In this case, the financial system evaluates the relation between the training data (such as documents filed to banks and market values of stock prices) and the classification information indicating a specified case (for example, when there is any possibility of a fraudulent purpose, or when the stock prices will increase) and can thereby, for example, detect notification filed for the fraudulent purpose or predict the stock prices in the future.

Furthermore, the data analysis system 1 can be also applied to a performance evaluation system. In this case, the performance evaluation system evaluates the relation between the training data (such as daily reports submitted by sales persons to a company and analysis materials submitted by consultants to clients) and the classification information indicating a specified case (for example, when the sales persons increase the sales results or when the consultants are evaluated by the clients) and can thereby, for example, conduct performance appraisal of the sales persons and consultants and evaluate successes or failures of projects.

For example, the data analysis system 1 can be also applied to a medical application system (a system for estimating whether a sick person may conduct a specific dangerous action by using electronic health records, nursing records, and patients' diaries as data). In this case, the medical application system extracts data elements included in the training data (such as electronic health records, nursing records, and patients' diaries) and evaluates the unknown data on the basis of whether the relevant data may be linked to the patient's specific dangerous action or not. Under this circumstance, the user may input judgment on the training data to determine whether the relevant data is data which may linked to the patient's specific dangerous action or not.

Then, the data evaluation unit 150 can estimate the patient's specific dangerous action based on the evaluation results of the data elements included in the unknown data (such as the electronic health records, nursing records, and patients' diaries). Under this circumstance, the partial data generation unit 140 breaks down the unknown data into the partial unknown data and the data evaluation unit 150 evaluates each piece of the partial unknown data.

Furthermore, the data analysis system 1 can be also applied to a mail monitoring system. In this case, the mail monitoring system (uses, for example, emails distributed daily over the network as data and) allows the user to evaluate, based on the content of the data, whether a person who wrote the relevant e-mail is dissatisfied with the organization or not (or whether they may possibly commit any wrongful act or not).

Then, the partial data generation unit 140 breaks down the unknown data (for example, a new e-mail) into the partial unknown data. The data evaluation unit 150 evaluates each piece of the partial unknown data. As a result, for example, it is possible to estimate whether an employee who wrote the e-mail in a company has complaints about, or feels dissatisfied with, the company or not (or whether they may possibly conduct any wrongful act) and thereby prevent any risk of the wrongful act by the employee (such as information leakage). Furthermore, under this circumstance, by clustering the unknown data evaluated as the person who created the unknown data having complaints or feeling dissatisfied, in order to see regarding what the person who created the unknown data has complaints or feels dissatisfied (for example, dissatisfied with their remuneration or dissatisfied with their labor environment), proportions of e-mails expressing complaints and dissatisfaction can be visualized, for example, as follows: “e-mails not expressing complaints or dissatisfaction: 92%; e-mails expressing dissatisfaction about the remuneration: 3%; e-mails expressing dissatisfaction about the labor environment: 2%; and others: 3%.” Furthermore, detailed analysis can be conducted by breaking down the unknown data and evaluating them.

Furthermore, the e-mails can also be used to prepare a personal correlation diagram on the basis of the emotional expressions included in the relevant e-mails. For example, when sending e-mails from a person of a subordinate position to a person of a superior position in a certain organization, it is difficult to send e-mails containing negative content; however, it is relatively easier for the person of the superior position to send such e-mails to the person of the subordinate position. So, it is possible to estimate the hierarchical relationship between members in the organization on the basis of the results of emotion analysis and senders and addressees of e-mails. For that purpose, the data analysis system 1 may include an estimation unit to estimate the relevant correlation. For example, the estimation unit extracts the data elements from a specified number of e-mails sent from person A to person B and detects emotions of user A, who wrote the e-mails, to check whether there are many affirmative e-mails or many negative e-mails. Then, if the estimation unit detects that there are many affirmative e-mails, it estimates that person A is subordinate to person B in terms of their positions; and if the estimation unit detects that there are many affirmative e-mails, it estimates that person A is superior to person B in terms of their positions.

Furthermore, the data analysis system 1 can be also applied to a performance evaluation system. In this case, the performance evaluation system evaluates whether the classified information (such as daily reports submitted by sales persons to a company, analysis materials submitted by consultants to clients, and user questionnaires about some kind of projects) is affirmative or negative, and evaluates the data elements indicative of the emotional expressions included in the classified information. Then, emotion analysis can be performed based on, for example, a user questionnaire at a shop as the unclassified information and the analysis result can be used as materials to judge the management situation of the shop (for example, whether customers are dissatisfied with shop clerks' attitude in helping and taking care of the customers, and whether they are satisfied with how products are displayed). Furthermore, the data analysis system 1 can also be applied to an intellectual property evaluation system, a marketing support system, a driving support system, and so on.

Furthermore, the data analysis system 1 can be also applied to a discovery support system. The discovery support system ranks, for example, data collected from people involved in a lawsuit (custodians) to see whether such data are related to the relevant lawsuit or not, by calculating a score with respect to the data (that is, evaluates the relation between the data and the relevant lawsuit).

Furthermore, the data analysis system 1 can be also applied to a forensic system. The forensic system ranks, for example, data seized from a suspect (search target) to see whether such data are related to a crime or not, by calculating a score with respect to the data (that is, evaluates the relation between the data and the crime).

Accordingly, the data analysis system 1 can be applied to not only the patent search system, but also to any system for achieving the purpose by evaluating the relation between data and a specified case, such as the forensic system, the discovery support system, the medical application system, the mail monitoring system, the Internet application system, the driving support system, the financial system, and the performance evaluation system. In any of the cases, the data analysis system 1 can evaluate the partial unknown data and/or the unknown data by dividing the unknown data into the partial unknown data which constitute at least part of the unknown data, and calculating a score of the relevant partial unknown data on the basis of the training data.

Particularly, the data analysis system 1 can: extract patterns from data by recognizing a group of data including a plurality of pieces of data as an “aggregate of data as a result of human thoughts and behaviors” and conducting, for example, analysis related to the human behaviors, analysis to predict the human behaviors, analysis to detect a specified human behavior, and analysis to suppress a specified human behavior; and evaluate the relation between the relevant patterns and the specified case.

### REFERENCE SIGNS LIST

1: data analysis system
100: data analysis apparatus
110: data acquisition unit
120: relation evaluation unit
130: evaluation storage unit
140: partial data generation unit
150: data evaluation unit
160: evaluation integration unit
162: sorting unit
164: score summing unit
170: output unit
180: score calculation unit
200: memory unit
210: document data memory unit
220: evaluation memory unit

### INDUSTRIAL APPLICABILITY

The present invention can be used for, for example, a data analysis technique capable of reducing burdens of patent researches. Furthermore, the present invention can be used for various data analysis techniques such as discovery support systems, forensic systems, mail monitoring systems, Internet application systems, medical application systems, performance evaluation systems, driving support systems, and project evaluation systems.

1. A data analysis system comprising a processor for data analysis and causing the processor to execute a data analysis program to analyze data,
wherein the processor:
sets training data which is a combination of data and classification information, the classification information being information to which a relation between a specified event and the data is input;
evaluates a relation between a data element included in the training data and the classification information;
divides unknown data, which is a target of the data analysis, into a plurality of parts, each of which includes the data element, and sets each of the plurality of parts as partial unknown data;
evaluates each of the plurality of pieces of the partial unknown data on the basis of evaluation results of the relation; and
evaluates the unknown data by selecting a specified number of the partial unknown data in descending order of the evaluation results of the plurality of pieces of the partial unknown data and integrating the evaluation results of the specified number of the selected partial unknown data.

2. The data analysis system according to claim 1,
wherein the processor evaluates each of the plurality pieces of the partial unknown data by calculating a score indicative of strength of a relation between each of the plurality pieces of the partial unknown data and the classification information.

3. The data analysis system according to claim 1,
wherein the unknown data is document data created according to a specified format including a plurality of items; and
wherein the processor generates the plurality of pieces of the partial unknown data by dividing the document data on the basis of the items as units.

4. A data analysis method for causing a processor to execute a data analysis program and analyzing data on the basis of classification information,
the methods comprising the following steps executed by the processor:
setting training data which is a combination of data and classification information, the classification information being information to which a relation between a specified event and the data is input;
evaluating a relation between a data element included in the training data and the classification information;
dividing unknown data, which is a target of the data analysis, into a plurality of parts, each of which includes the data element, and setting each of the plurality of parts as partial unknown data;
evaluating each of the plurality of pieces of the partial unknown data on the basis of evaluation results of the relation; and
evaluating the unknown data by selecting a specified number of the partial unknown data in descending order of the evaluation results of the plurality of pieces of the partial unknown data and integrating the evaluation results of the specified number of the selected partial unknown data.

5. A computer-readable storage medium with a program,
the program analyzing data on the basis of classification information and causing the computer to implement the following functions that:
sets training data which is a combination of data and classification information, the classification information being information to which a relation between a specified event and the data is input;
evaluates a relation between a data element included in the training data and the classification information;
divides unknown data, which is a target of the data analysis, into a plurality of parts, each of which includes the data element, and sets each of the plurality of parts as partial unknown data;
evaluates each of the plurality of pieces of the partial unknown data on the basis of evaluation results of the relation; and
evaluating the unknown data by selecting a specified number of the partial unknown data in descending order of the evaluation results of the plurality of pieces of the partial unknown data and integrating the evaluation results of the specified number of the selected partial unknown data.

6. A data analysis method comprising the following steps executed by a processor:
a data acquisition step of acquiring, as a training data set, a data set including a plurality of combinations of training data and classification information for classifying the training data;
a relation evaluation step of evaluating a relation between a data element included in the training data and the classification information;
a partial data generation step of dividing each of a plurality of pieces of unknown data, which are analysis targets, into partial unknown data which constitute part of each pieces of the unknown data; and
a data evaluation step of evaluating each piece of the partial unknown data on the basis of evaluation results by the relation evaluation unit.

7. A data analysis program for causing a computer to implement:
a data acquisition function that acquires, as a training data set, a data set including a plurality of combinations of training data and classification information for classifying the training data;
a relation evaluation function that evaluates a relation between a data element included in the training data and the classification information;
a partial data generation function that divides each of a plurality of pieces of unknown data, which are analysis targets, into partial unknown data which constitute part of each pieces of the unknown data; and
a data evaluation function that evaluates each piece of the partial unknown data on the basis of evaluation results by the relation evaluation unit.
